(19) United States
(12) Patent Application Publication
(10) Pub. No.: US 2007/0294351 A1
(43) Pub. Date: Dec. 20, 2007

(54) Method for the Monitoring the Transmission of Electronic Messages

(76) Inventor: Hisham Arnold El-Emam, Bochum (DE)

Correspondence Address: DONN K. HARMS;PATENT & TRADEMARK LAW CENTER, SUITE 100, 12702 VIA CORTINA, DEL MAR, CA, 92014, US

(21) Appl. No.: 10/594,169

(22) PCT Filed: Mar. 26, 2004
(86) PCT No.: PCT/EP04/03268

§ 371 Date: Jun. 21, 2007

(51) Int. Cl. G06F 15/16

(52) U.S. Cl. 709/206

(57) ABSTRACT

The invention relates to a method for the computer-aided monitoring of the transmission of electronic messages within a data network (1). According to said method, a sender identification statement of an incoming electronic message is first determined, whereupon an electronic database (11) is interrogated and verification is made as to whether said sender identification statement is registered in the database (11) as an acceptable or unacceptable sender identification statement. The incoming electronic message is finally transmitted in accordance with the verification result. According to the invention, entries concerning acceptable sender identification statements are automatically generated in the database (11), identification statements to the data network (1) of connected computers (2, 3, 4, 5) being stored in the database (11) at least as components of acceptable identification statements when outgoing data communication addressed to said computers (2, 3, 4, 5) is registered.

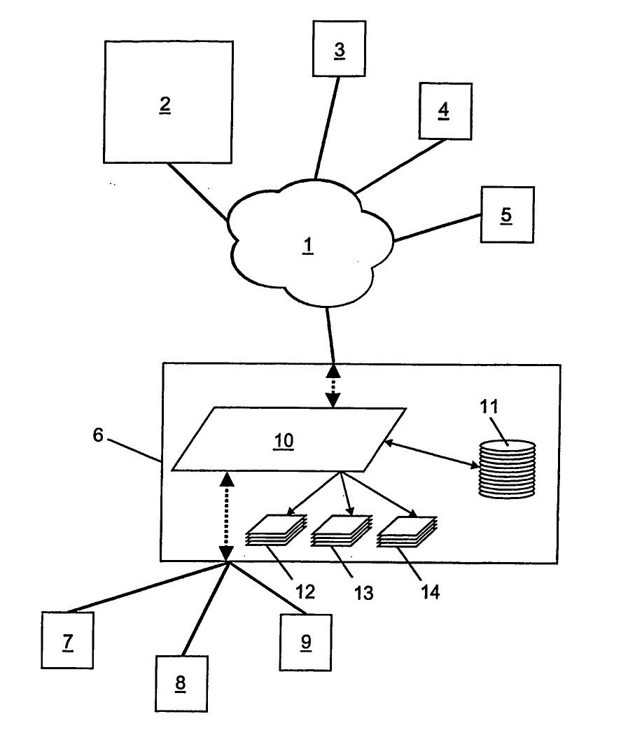

The invention relates to a process for the computer-supported monitoring of the transmission of electronic messages within a data network. According to the process, sender identification information of an incoming electronic message is first ascertained. An inquiry is then made with an electronic database and a check is performed to determine whether the sender identification information is registered in the database as acceptable or unacceptable sender identification information. Finally, the incoming electronic message is transmitted depending on the result of the check.

Communication by means of electronic messages, so-called e mails, transmitted within a company or worldwide via the Internet or other data network is common nowadays. Substantial advantages of communication by means of e mails are the high speed of the information transmission and the low costs.

Recently the high availability and low costs have caused the e-mail medium to be used increasingly to disseminate advertising. Therefore, Internet users are increasingly receiving unsolicited e-mails that are sent primarily as mass e-mails by so-called “spammers.” Spammers have different techniques at their disposal for obtaining information with respect to the identification information, i.e., e-mail addresses, of potential spam recipients. For example, inquiries are made automatically with suitable Internet sites, such as news sites (“newsgroup sites”), Internet forums (“chat room sites”), data from so-called mailing lists or e-mail addresses otherwise retrievable on the Internet. By means of such methods, the spammers obtain e-mail addresses, which are then used as a target for advertising or other unwanted electronic messages.

To the extreme frustration of most Internet users, their electronic mailboxes are increasingly flooded with “spam,” i.e., unwanted electronic messages of the aforementioned type. It takes time to sort out and delete the unwanted messages. In addition, transmission of spam to the recipients wastes transmission bandwidth, which creates costs for the recipients, who pay fees to their Internet service providers for data transmission. Spam is also a serious problem for the Internet service providers themselves, such as AOL, T online, etc., because their customers are dissatisfied as a result of the disadvantages described above.

Various techniques already exist today to prevent and block spam. Relevant programs that monitor the transmission of electronic messages via data networks are also referred to as spam filters. One well-known category of spam filters works with so-called white lists. White lists are electronic databases, in which acceptable sender identification information is stored for the transmission of electronic messages. Such spam filters first ascertain the sender identification information, i.e., the e-mail address, of the sender of an incoming electronic message. This sender address is then compared to the addresses stored on the white list. If the address on the white list is registered as an acceptable address, the incoming electronic message is forwarded to the relevant recipient. If necessary, an individual white list can be assigned to each individual recipient of electronic messages. But the use of comprehensive databases with acceptable sender addresses, such as for all customers of an Internet service provider, is also known. The use of black lists, i.e., databases that exclusively contain unacceptable sender identification information, is also known. The sender addresses of known spam senders are thus registered on the black lists. Messages sent by these spammers are then automatically recognized and blocked.

The spam filters operating according to the described process of white lists have a series of disadvantages. One substantial disadvantage results from the fact that e-mails are frequently identified as spam, in spite of the fact that they are not unwanted messages. This results in the relevant messages erroneously not reaching their recipients. The reason for this that, as described above, only e-mails whose sender is listed as acceptable are delivered. In the case of spam filters that operate with white lists, the database with acceptable sender addresses is usually generated in such a manner that, upon receipt of an e-mail from a previously unknown sender, the sender automatically receives a response message generated by the spam filter, which must, in turn, be confirmed by the sender of the message suspected of being spam. If the confirmation is then received, the sender address is automatically incorporated into the white list, and the originally received e-mail is duly delivered. It is problematical in this regard, first of all, that some spammers have now switched over to likewise automatically answering spam filters' automatically generated confirmation messages, and as a result the spam filter is circumvented. An additional disadvantage is the fact that certain wanted electronic messages can never pass such spam filters operating with white lists. This applies, for example, to e-mails that are sent to the subscribers of so-called mailing lists. The senders of messages to the subscribers of mailing lists generally do not answer the spam filter's confirmation messages. In addition, wanted e-mails that are automatically generated by Internet servers, such as order confirmations in connection with e-commerce transactions, are also blocked.

Starting from this point of departure, this invention is based on the problem of providing a further developed process for a spam filter that operates with white lists in the manner described above and avoids the aforementioned disadvantages.

The invention solves this problem by means of the fact that entries relating to acceptable sender identification information are automatically generated in the database by means of the fact that identification information of computers connected to the data network is stored in the database at least as components of acceptable sender identification information, if outgoing data traffic directed to such computers is registered.

Accordingly, the basic idea of the invention is to monitor the behavior of Internet users in an automated manner; based on the data traffic that arises as a result of the users' activities, conclusions are drawn as to the senders from which e-mails are to be accepted.

The process set forth in the invention has the advantage that the automated sending of confirmation e-mails, as is required in order to generate entries in the relevant white lists in the case of known spam filters, can be avoided. Analysis of the outgoing data traffic is sufficient to generate the necessary entries into the electronic database. An additional advantage is the fact that definitely wanted e-mails from Internet servers, such as order confirmations in the case of e-commerce transactions, are able to pass the spam filter, because, according to the invention, the server's acceptable sender identification information is automatically ascertained and stored in the database using the outgoing data traffic during the order process carried out via the data network.

According to the invention, recipient identification information of outgoing electronic messages can more sensibly be stored in the database as acceptable sender identification information. Thus, if an Internet user sends an e-mail, the recipient's e-mail address is automatically stored on the white list as an acceptable sender address. For recipients that have already received an e-mail from the Internet user, therefore, this eliminates the necessity of carrying out the time-consuming and cumbersome confirmation process to generate the entry on the white list. It is conceivable to continue to provide for automated confirmation as a supplement to the process set forth in the invention, if an electronic message is received from an e-mail sender that is not yet registered as acceptable.

If, in the process set forth in the invention, the identification information of a server computer connected to the data network is stored in the database as a component of acceptable sender identification information, it is also sensible if, in the outgoing data traffic, the request for a service from such server computer via the data network is registered. This design of the spam filter set forth in the invention relates, for example, to the data traffic mentioned above within the framework of e-commerce transactions. During the order process, it can be determined using the outgoing data traffic that an Internet user is requesting a service from the relevant e-commerce server. In the case of participation in an Internet auction by the service provider eBay, for example, it is possible based on the outgoing data traffic to determine that the Internet user is visiting the Internet page “www.ebav.com.” The second-level domain title “eBay” is then registered as identification information within the meaning of the invention and stored on the white list of the spam filter, such that, after the order process, e-mails that contain the domain information “eBay” as a component in the sender address, such as .sender(a>ebav.com” or .info(a>ebav.de”., can pass the spam filter and reach the Internet user as desired.

One advantageous further development of the process set forth in the invention lies in the fact that an automatically generated entry of acceptable sender identification information in the database is deleted after the expiration of a definable time interval. It can easily occur that an Internet user will—perhaps inadvertently—generate outgoing data traffic directed to a server that sends spam. According to the invention, the identification information of such server would be registered on the database as a component of acceptable sender identification information. In order to prevent spam from being permanently delivered by such a server, it can be provided that the identification information on the white list will be deleted after the expiration of a definable time interval.

It is also sensible if the sender identification information is stored in the database in coded form. Otherwise, the working method of the spam filters set forth in the invention could be abused to spy out the data traffic generated by an Internet user, in order, for example, to analyze the user's “surfing” behavior on the Internet. It is particularly sensible therefore to provide for a known one-way coding process for the coding of the entries in the database, such that it is possible to compare the sender addresses of incoming e-mails against the acceptable addresses stored on the white list, but it is not possible to reconstruct the acceptable addresses themselves from the database content.

The process set forth in the invention can easily be used on the personal computers of any Internet user. It is expedient in this regard that accesses to server computers via the data network be automatically recorded by means of an application program and that the outgoing data traffic later be analyzed on the basis of the record in order to generate entries in the database. The generation of the record can be controlled by means of suitable programming of a typical browser program to access servers on the Internet. An appropriately adapted e-mail program can ascertain the acceptable sender identification information and enter it onto the white list by evaluating the record.

Alternatively, the possibility also exists to implement the process set forth in the invention on a server that is connected to the data network and forwards the incoming and outgoing data traffic. In particular, this has the advantage that the unwanted electronic messages are intercepted early, such that the least amount of bandwidth is wasted for the transmission of these messages to the individual Internet users. For example, the spam filter that operates according to the invention can be installed on a so-called gateway computer or proxy server. Data content available on the Internet (Web pages) is stored on a proxy server on an intermediate basis, in order to thereby enable a more effective utilization of the transmission bandwidth within the data network. By means of a proxy server, it is particularly simple to register the request for a service from a Internet server in the outgoing data—something which can be utilized for the implementation of the spam filter set forth in the invention. As an additional alternative, the filter set forth in the invention can also be located upstream from a so-called mail server, i.e., a server computer responsible for e-mail transmission, of an internet service provider, such that the mail server is already relieved of spam.

A design example of the invention is explained below with the help of the drawing. The drawing shows the monitoring set forth in the invention of the transmission of electronic messages within a data network in the form of a block diagram.

A server computer 2 and several additional computers 3, 4 and 5 are connected to a global data network 1, which can, for example, be the Internet. The computers 3, 4 and 5 are the personal computers of Internet users. In addition, a server computer 6 of an Internet service provider is connected to the Internet 1. The server computer 6 is a so-called mail server, which is used to forward incoming electronic messages, i.e., e-mails, from the Internet 1 to the Internet service provider's customers. Personal computers 7, 8 and 9 that are assigned to the customer of the Internet service provider are connected to the mail server 6. A program 10 operating according to the process set forth in the invention is running on the mail server 6. The program 10 ascertains sender identification information, i.e., sender addresses, of incoming e-mails on the server 6. An inquiry is then made to an electronic database 11, along with a check of whether the ascertained sender address is registered in the database 11 as acceptable or unacceptable. Depending on the result of the check, the incoming e-mails are either rejected or stored in mailboxes 12, 13 and 14, which are assigned to the computers 7, 8 and 9. By means of the program 10, acceptable sender addresses are automatically ascertained and stored in the database 11. For this purpose, the identification information of the computers 2, 3, 4 and 5 connected to the data network 1, i.e., the e-mail addresses or domain names assigned to these computers, is stored in the database 11 as acceptable sender addresses in the form of a white list, if any data traffic emanating from computers 7, 8 or 9 and directed to these computers 2, 3, 4 and 5 is registered.

If, for example, an e-mail is sent from computer 7 to computer 3 via the mail server 6 and the Internet 1, the program 10 registers the recipient address of the outgoing e-mail and stores it in the database 11 as an acceptable sender address. If, at a later point in time, an e-mail is sent from computer 3 to computer 7, this e-mail can pass the spam filter implemented by the program 10, since the sender address of the e-mail is stored in the database 11 as an acceptable sender address.

If the server computer 2 is a spammer, the e-mails emanating from the spammer 2 will not be forwarded by the mail server 6, because the program 10 is not able, after an inquiry of the database 11, to verify that the sender address of the server 2 is an acceptable sender address.

In addition, the program 10 monitors the outgoing data traffic with respect to requests for services from computers connected to the data network 1. If, for example, the computer 9 retrieves an Internet page stored on computer 5, the domain name assigned to computer 5, or at least a component thereof, is automatically stored by the program 10 as an acceptable sender address in the database 11. If, at a later point in time, an e-mail is sent from computer 5 to computer 9, this e-mail can pass the spam filter operating according to the invention, because the program 10 identifies the domain name of computer 5 as an acceptable sender address by accessing the database 11.

Finally, according to the invention, the data traffic generated by computers 7, 8 and 9 is monitored by means of the server 6, on which the program 10 runs, in order to ascertain acceptable sender addresses based on the outgoing data traffic, which are stored in the form of a white list by means of the database 11. If the sender address of an e-mail received on the server 6 matches an address stored in the database 11, the e-mail is not viewed as spam and is forwarded to the relevant recipients.

1. Process for the computer-supported monitoring of the transmission of electronic messages within a data network (1), with the five following procedural steps:
a) Ascertainment of the sender identification information of an incoming electronic message,
b) inquiry to an electronic database (11) and a check to determine whether the sender identification information is registered in the database (11) as acceptable or unacceptable sender identification information,
c) transmission of the electronic message depending on the result of the check in procedural step b), characterized by the fact the entries are automatically generated in the 5 database (11) relating to acceptable sender identification information by means of the fact that identification information of computers (2, 3, 4, 5) connected to the data network (1) is stored in the database (11) at least as components of acceptable sender identification information, if the outgoing data traffic directed to these computers (2, 3, 4, 5) is registered.

2. Process according to claim 1, characterized by the fact that recipient identification information of outgoing electronic messages is stored in the database (11) as acceptable identification information.

3. Process according to claim 1, characterized by the fact that the identification information of a server computer (2) connected to the data network is stored in the database (11) as a component of acceptable sender identification information, if a request for a service from such server computer (2) via the data network (1) is registered in the outgoing data traffic.

4. Process according to one of the claims 1 through 3, characterized by the fact that an automatically generated entry of acceptable sender identification information is deleted from the database (11) after the expiration of a definable time interval.

5. Process according to one of the claims 1 through 4, characterized by the fact that the sender identification information is stored in the database (11) in coded form.

6. Process according to one of the claims 3 through 5, characterized by the fact that accesses to server computer (2) via the data network are automatically recorded by means of an application program (10) and by the fact that the outgoing data traffic is thereafter analyzed on the basis of the record in order to generate entries in the database (11).

7. Process according to one of the claims 1 through 5, characterized by the fact that the process is implemented on a server (6) that is connected to the data network and forwards incoming and outgoing data traffic.
